(19) United States
(12) Patent Application Publication
(10) Pub. No.: US 2008/0143010 A1
(43) Pub. Date: Jun. 19, 2008

(54) Chemical coating composition for glass fibers for improved fiber dispersion

(76) Inventors: Sanjay Kashikar, Kelmis (BE); Jean-Marc P. Henrion, Theux (BE); Philip T. Van Den Brande, Hulst (NL)

Correspondence Address: OWENS CORNING, 2790 COLUMBUS ROAD, GRANVILLE, OH, 43023, US

(21) Appl. No.: 11/639,672

(22) Filed: Dec. 15, 2006

(51) Int. Cl. B27N 3/04; D02G 3/00; B32B 5/16

(52) U.S. Cl. 264/112; 428/378; 428/403

(57) ABSTRACT

A coating composition that improves fiber dispersion and mechanical properties in reinforced composite articles is provided. The coating composition includes a chemical compound that acts as an emulsifier, a surfactant, and a melt viscosity reducer. In at least one exemplary embodiment, the chemical compound is an ethoxylated fatty acid or an ethoxylated fatty alcohol compound. The coating composition may be applied to the reinforcing fiber strand after a conventional sizing composition has been applied to the reinforcing fiber and prior to wire coating the fiber with a thermoplastic resin. The coated/sized fiber strands may be chopped to form chopped strand segments and then densified or compacted to form a densified reinforcing fiber product, such as pellets. These pellets, in turn, may be used to form polymer reinforced composite articles. In alternative embodiments, the coating composition may be applied directly to the reinforcement fibers directly after fiber formation under the bushing.

### TECHNICAL FIELD AND INDUSTRIAL APPLICABILITY OF THE INVENTION

The present invention relates generally to a sizing composition for a reinforcing fiber material, and more particularly, to a chemical composition that provides improved fiber dispersion in a composite article.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, meshes, and scrims to reinforce polymers. It is known in the art that glass fiber reinforced polymer composites offer generally good mechanical properties in terms of impact, toughness, and strength, provided that the reinforcement fiber surface is suitably modified by a sizing composition.

Typically, glass fibers are formed by attenuating streams of a molten glass material from a bushing. An aqueous sizing composition, or chemical treatment, containing lubricants, coupling agents, and film-forming binder resins are typically applied to the fibers after they are drawn from the bushing. The sizing composition protects the fibers from interfilament abrasion and promotes compatibility and adhesion between the glass fibers and the matrix in which the glass fibers are to be used. After the fibers are treated with the aqueous sizing composition, they may be dried and formed into a continuous fiber strand package or chopped into chopped strand segments.

The chopped strand segments may be compounded with a polymeric resin during an extrusion process and the resulting short fiber, compounded pellets may be supplied to a compression- or injection-molding machine to be formed into glass fiber reinforced composites. For example, the chopped strand segments may be mixed with a thermoplastic polymer resin in an extruder and formed into compounded pellets. These dry pellets may then be fed to a molding machine and formed into molded composite articles.

On the other hand, the continuous fiber strand packages may be used in long fiber thermoplastic composite fabrication using a direct long fiber thermoplastic (D-LFT) process or a pelletization process. In direct long fiber thermoplastic processes, the long fiber thermoplastic composite part may be molded in a single step by a lower shear extrusion-, injection-, or extrusion-compression process. In pelletization processes, the continuous fiber strands may be impregnated with thermoplastic resins in an impregnation die, after which the coated, continuous strands are chopped into pellets of desired lengths. Alternatively, the continuous fiber strands may be wire coated using thermoplastic resins to form an overcoated strand that may be chopped in-line into pellets of desired lengths. These long fiber thermoplastic pellets may then be molded into long fiber thermoplastic parts using low shear injection- or compression-molding processes.

An example of forming pellets by a wire coating process for use in long fiber thermoplastic processing is depicted in FIG. 1. Continuous glass fibers may be sized with an aqueous or non-aqueous sizing composition either during or after fiber production. Non-aqueous size compositions may contain components such as waxes, oils, lubricants, and/or coupling agents (such as a substantially non-hydrolyzed silane) in solid or non-aqueous liquid form. In addition, if the components of the non-aqueous sizing are originally in a solid form, the non-aqueous sizing may be used in a molten state and applied to the glass fibers during their manufacturing. Aqueous sizing compositions may contain film forming agents, a coupling agent, and/or a lubricant in an aqueous phase.

In FIG. 1, continuous glass fibers were previously sized with a non-aqueous sizing composition to form continuous sized glass fibers 10. The continuous sized glass fibers 10 may be passed through a shaped dye or wire coater 12 to substantially coat a thermoplastic polymer 13 around the glass fibers 10. Optionally, additives 11 may be applied to the sized glass fibers 10 with the thermoplastic polymer 13. The encapsulated fibers 14 are then passed through a cooling apparatus 16 or may be air dried or air cooled (not shown) to solidify the polymer sheath around the fibers 14. The thermoplastic encased fibers 14 may be pelletized to a length that is suitable for long fiber thermoplastic processing and long fiber thermoplastic composite part requirements using a pelletizer 18. The long fiber thermoplastic pellets 20 may be molded into composite parts using conventional high shear injection- or compression-molding machines or lower shear long fiber thermoplastic (LFT) molding processes.

Although long fiber thermoplastic composite parts formed by molding pelletized thermoplastic encased fibers sized with a sizing composition (as shown in FIG. 1) possess adequate mechanical properties, the glass fibers do not always disperse well in the polymer matrix, resulting in undesirable visual defects in the final composite product. In addition, poor fiber dispersion may result in inconsistent part quality, which may affect properties such as tensile, impact, and flexural strengths of the final composite part. In addition, when a lower melting, non-aqueous sizing is used on glass fibers suitable for wire coating pelletization and subsequent long fiber thermoplastic molding processes, temperature dependent issues such as fuzz generation, broken filaments, and line stopping may occur during a wire coating pelletization process. In addition, compared to the virtually unlimited selection of aqueous sizing chemicals and compositions available for use in fiber manufacturing processes, there are only a limited number of choices currently available for non-aqueous sizing compositions that may be applied during fiber manufacturing processes. Thus, making improvements in the mechanical properties of long fiber thermoplastic composite articles is difficult when a non-aqueous sizing is used compared to when a conventional aqueous sizing is utilized.

Further, in conventional high shear molding processing, the fiber lengths may be significantly reduced, causing the final composite part to lose physical properties such as tensile and impact strengths. In order to retain the physical properties generally attributed to long fiber thermoplastic processing, the fibers should maintain their length and be well dispersed in the final long fiber thermoplastic composite article. The long fiber thermoplastic industry has attempted to improve fiber length retention in the final LFT composite part by altering screw designs and/or by lowering the mixing shear during processing. Although new screw designs and lowering the mixing shear help to maintain the fiber length in the composite article, it becomes increasingly difficult to evenly disperse the long fibers in the composite article as the mixing shear lowers. Even though increasing the mixing shear improves the fiber dispersion, the higher shear typically undesirably damages and reduces the fiber length in the composite article.

In addition, fibers in pellets produced by high speed wire coating processes using conventionally aqueous sized fibers do not disperse well in the final composite part, especially when the pellets are molded under lower shear conditions. Parameters such as screw speeds, pressures, and temperatures are adjusted to achieve a desired shear. Additionally, the type of resin material, melting points, viscosities, glass fiber concentration, and compounding additives may influence how a particular shear is achieved. It is to be appreciated that in order to retain the fiber length in long fiber thermoplastic composites, the equipment design and mold settings in long fiber thermoplastic molding processes are generally adjusted in such a way as to exert a much lower shear compared to short fiber composite fabrication processes. As a result, wire coated pellets based on conventional aqueous-sized fibers generally do not produce well-dispersed long fiber thermoplastic composite parts when molded under low shear conditions.

Thus, there exists a need in the art for a cost-effective sizing composition that provides excellent fiber dispersion in the final composite article under conventional long fiber thermoplastic shear molding conditions and that provides improved mechanical properties to the final reinforced composite part.

### SUMMARY OF THE INVENTION

It is an object of the present invention to provide a reinforcing fiber strand that is formed of a plurality of individual reinforcement fibers that are at least partially coated with a sizing composition. In particular, the reinforcing fiber strand is at least partially coated with a coating composition that contains a chemical compound or compounds that provides excellent fiber dispersion in the final composite articles. Preferably, the chemical compound includes an ethoxylated fatty acid, an ethoxylated fatty alcohol, or a mixture of an ethoxylated fatty acid and an ethoxylated fatty alcohol. The coating composition may optionally contain additives to improve the coating efficiency and/or impose desired properties or characteristics to the coating composition or to the final composite product. The sizing composition may be applied to the individual reinforcing fibers prior to being gathered into a reinforcing fiber strand and prior to the application of the coating composition to the reinforcing fiber strand. The individual reinforcing fibers or fiber strands may be dried, either partially or completely, using conventional or radio frequency (RF) drying equipment prior to or during the pelletization process. In addition, the sizing composition may be aqueous or non-aqueous. In one exemplary embodiment, the sizing composition is a non-aqueous sizing composition and the coating composition is incorporated as a component of the sizing composition. The molten non-aqueous sizing composition containing the coating composition may be applied to the individual reinforcement fibers. In such an embodiment, the sizing composition solidifies onto the reinforcement fibers upon cooling, and no further drying is necessary. In another embodiment, the inventive coating composition may be partially incorporated into a conventional aqueous sizing composition (e.g., a composition containing lubricants, coupling agents, and film-forming binder resins in aqueous form) and applied to the individual reinforcement fibers during fiber formation. A second portion of the coating composition may be applied either in-line or off-line to the reinforcing fiber strand prior to or after it has been dried. The reinforcing fiber strand may also be surrounded by a sheath of a thermoplastic polymer prior to forming the reinforcing fiber strand into a reinforcing fiber product, such as a pellet.

It is another object of the present invention to provide a reinforcing fiber product formed of two or more reinforcing fiber strands formed of a plurality of reinforcing fibers at least partially coated with a sizing composition. One or both of the reinforcing fiber strands or reinforcing fibers is at least partially coated with a coating composition that includes a chemical compound or compounds that provides improved dispersion of the reinforcing fibers in a polymer matrix. In at least one exemplary embodiment of the invention the chemical compound is an ethoxylated fatty acid, an ethoxylated fatty alcohol, or a mixture of an ethoxylated fatty acid and an ethoxylated fatty alcohol. The coating composition may be applied to the reinforcing fiber strand prior to wire coating or overcoating the fiber strand with a thermoplastic resin. The reinforcing fiber strand and/or reinforcing fibers may have been dried, either partially or completely, using a conventional oven and/or radio frequency (RF) drying equipment prior to forming fiber reinforced thermoplastic pellets. Individual reinforcing fibers forming the reinforcing fiber strand may have been previously applied with an aqueous or a non-aqueous sizing composition. The sized/coated reinforcement fiber strand may be overcoated with a thermoplastic resin using a wire coating process. The thermoplastic resin(s) may be optionally combined with desired additives to impart desired characteristics to the reinforcing fiber product. The thermoplastic resin forms a sheathed strand that may be chopped into pellets that may be molded into a long fiber thermoplastic composite article. Alternatively, the coating composition may be applied onto the individual reinforcement fibers with the sizing composition when the coating composition is included as part of an aqueous or a non-aqueous sizing composition in a molten state. The sized/coated reinforcement fiber strand may then be chopped into segments and formed into pellets, which may then be molded into composite articles that have a substantially homogeneous dispersion of glass fiber strands throughout the composite article, even under low long fiber thermoplastic shear molding conditions.

It is yet another object of the present invention to provide a method of forming a reinforced composite article that includes fiber strands substantially coated with the inventive coating composition. A coating composition containing a chemical compound is applied to reinforcing fiber strands coated with an aqueous or non-aqueous sizing composition. The chemical compound is preferably an ethoxylated fatty acid, an ethoxylated fatty alcohol, or a mixture of an ethoxylated fatty acid and an ethoxylated fatty alcohol. The individual reinforcement fibers forming the reinforcement fiber strands may be fibers previously coated with an aqueous or non-aqueous sizing composition. Alternatively, the size composition may be applied to the individual reinforcement fibers forming the fiber strand prior to the application of the coating composition to the reinforcing fiber strand. The coating composition may then be applied in-line prior to passing the reinforcement fibers through a wire coating apparatus to substantially evenly coat a thermoplastic polymer circumferentially around the coated reinforcement fiber strand. Desired additives may be added to the fiber strand with the thermoplastic polymeric material. The overcoated reinforcement fiber strands may then be chopped into segments using a pelletizing apparatus. The pellets may be fed to a molding machine and formed into molded composite articles that have a substantially homogeneous dispersion of glass fibers throughout the composite article, even under low shear molding conditions. In an alternate embodiment, the size composition is an aqueous sizing composition and a portion of the coating composition is incorporated into the size composition.

It is a further object of the present invention to provide a method of forming a composite article that includes reinforcing fibers that are at least partially coated with a coating composition that includes a chemical compound that is desirably an ethoxylated fatty acid, an ethoxylated fatty alcohol, or an ethoxylated fatty acid and an ethoxylated fatty alcohol. The coating composition may be included as part of an aqueous or a non-aqueous sizing composition. The aqueous or non-aqueous sizing composition containing the inventive coating composition may be applied to the reinforcement fibers after they are drawn from a bushing by any conventional applicator. In the case of non-aqueous sizing compositions, the molten non-aqueous sizing composition solidifies onto the reinforcement fibers upon cooling. When an aqueous sizing composition is utilized, the gathered strands may be dried using conventional or radio frequency drying equipment. As a result, with a non-aqueous sizing, no further drying is necessary. The sized/coated reinforcement fibers may be gathered by a gathering mechanism to form coated reinforcement fiber strands. The coated strands may then be wound into a continuous fiber strand package or chopped into a desired length prior to, during, or after the fibers/strands have been dried. Subsequently, the coated fibers (continuous or chopped) may be pelletized into pellets utilizing a pelletizing apparatus and molded into reinforced long fiber thermoplastic composite articles.

It is an advantage of the present invention that composite articles formed from fibers coated with the coating composition of the present invention demonstrate improved mechanical properties and excellent fiber dispersion, even at low shear long fiber thermoplastic molding conditions.

It is another advantage of the present invention that the coating composition assists in substantially evenly dispersing the reinforcement fibers in the polymer matrix and thus in the final composite article. Such improved dispersion of the reinforcement fibers results in fewer visual defects in the composite article.

It is a further advantage of the present invention that the improved dispersion of the fibers in the composite part enhances the quality and performance consistency of the composite part.

It is yet another advantage of the present invention that the fibers and/or strands coated with the coating composition are suitable for any conventional or long fiber thermoplastic compounding and/or molding process, including high speed wire coating or pelletization processes.

It is also an advantage of the present invention that the fibers and/or strands coated with the coating composition form pellets that provide improved fiber dispersion in the final composite part upon molding.

It is another advantage of the present invention that the fibers and/or strands coated with the coating composition provide improved fiber dispersion in the final composite part, even when the reinforcement fibers have been applied with an aqueous sizing composition.

It is a further advantage of the present invention that the fibers and/or strands coated with the coating composition provide improved mechanical performance and good fiber dispersion in the final composite part when the reinforcement fibers have been applied with an aqueous sizing composition that includes a high molecular weight maleated polypropylene film former emulsion and have been dried using radio frequency drying equipment.

It is another advantage of the present invention that the coating composition may be applied in single or multiple steps to the reinforcing fibers or fiber strands prior to molding into a final composite part.

It is a feature of the present invention that the coating composition may be applied to reinforcement fibers sized with a conventional sizing composition or applied to reinforcement fibers under a bushing after fiber formation as a component of a non-aqueous sizing composition.

It is another feature of the present invention that the coating composition may be incorporated as a part of a conventional aqueous or non-aqueous sizing that is to be applied to reinforcement fibers during or after fiber formation.

The foregoing and other objects, features, and advantages of the invention will appear more fully hereinafter from a consideration of the detailed description that follows.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a conventional pelletizing process using fibers coated with either an aqueous or non-aqueous sizing composition;

FIG. 2 is a schematic illustration of a pelletizing process using fibers coated with either an aqueous or non-aqueous sizing composition according to at least one embodiment of the present invention;

FIG. 3 is a schematic illustration of the application of the coating composition to reinforcement fibers after the fibers are formed from a bushing according to at least one exemplary embodiment of the present invention;

FIG. 4 is a photographic depiction of a long fiber thermoplastic molded plate formed from pellets that include fibers having thereon a conventional sizing composition and no coating composition;

FIG. 5 is an X-ray of the photograph depicted in FIG. 4;

FIG. 6 is a photographic depiction of a long fiber thermoplastic molded plate formed from pellets that include a conventional sizing composition and a coating composition formed of an ethoxylated fatty alcohol (ethyoxylation of n=20 and a C₁₈ fatty alcohol) applied at an amount of 10% by weight;

FIG. 7 is an X-ray of the photograph depicted in FIG. 6;

FIG. 8 is a photographic depiction of a long fiber thermoplastic molded plate formed from pellets that include a conventional sizing composition and a coating composition formed of an ethoxylated fatty alcohol (ethyoxylation of n=20 and a C₁₈ fatty alcohol) applied at an amount of 8.0% by weight;

FIG. 9 is a photographic depiction of a long fiber thermoplastic molded plate formed from pellets that include a conventional sizing composition and a coating composition formed of an ethoxylated fatty alcohol (ethyoxylation of n=20 and a C₁₈ fatty alcohol) applied at an amount of 6.0% by weight;

FIG. 10 is a photographic depiction of a long fiber thermoplastic molded plate formed from pellets that include a conventional sizing composition and a coating composition formed of an ethoxylated fatty alcohol (ethyoxylation of n=20 and a C₁₈ fatty alcohol) applied at an amount of 4.0% by weight;

FIG. 11 is a photographic depiction of a long fiber thermoplastic molded plate formed from pellets that include a conventional sizing composition and a coating composition formed of an ethoxylated fatty acid (PEG1500MS) applied at an amount of 10% by weight;

FIG. 12 is a photographic depiction of a long fiber thermoplastic molded plate formed from pellets that include a conventional sizing composition and a coating composition formed of an ethoxylated fatty acid (PEG1500MS) applied at an amount of 7.0% by weight;

FIG. 13 is a photographic depiction of a long fiber thermoplastic molded plate formed from pellets that include a conventional sizing composition and a coating composition formed of an ethoxylated fatty acid (PEG1500MS) applied at an amount of 5.0% by weight;

FIG. 14 is a photographic depiction of a long fiber thermoplastic molded plate formed from pellets that include a conventional sizing composition and a coating composition formed of a low molecular weight maleated polypropylene applied at an amount of 8.0% by weight;

FIG. 15 is a photographic depiction of a long fiber thermoplastic molded plate formed from pellets that include a conventional sizing composition and a coating composition formed of a mixture of hyperbranched polyethylene mixed with two different microstalline waxes applied at an amount of 10% by weight;

FIG. 16 is a photographic depiction of a long fiber thermoplastic molded plate formed from pellets that include a conventional sizing composition and a coating composition formed of an ethoxylated fatty alcohol (ethyoxylation of n=9-11 and a C₆ fatty alcohol) applied at an amount of 8.0% by weight where the sizing composition is dried in a radio frequency drying apparatus;

FIG. 17 is a photographic depiction of a long fiber thermoplastic molded plate formed from pellets that include a conventional sizing composition and a coating composition formed of an ethoxylated fatty alcohol (ethyoxylation of n=10 and a C₁₈ fatty alcohol) applied at an amount of 8.0% by weight where the sizing composition is dried in a radio frequency drying apparatus;

FIG. 18a is a photographic depiction of a long fiber thermoplastic molded plate formed from pellets that include a non-aqueous sizing composition and a coating composition formed of an ethoxylated fatty alcohol (ethyoxylation of n=20 and a C₁₈ fatty alcohol) applied under the bushing during fiber formation at an amount of 8.0% by weight;

FIG. 18b is a photographic depiction of a long fiber thermoplastic molded plate formed from pellets that include a non-aqueous sizing composition and a coating composition formed of an ethoxylated fatty alcohol (ethyoxylation of n=20 and a C₁₈ fatty alcohol) applied under the bushing during fiber formation at an amount of 7.0% by weight;

FIG. 18c is a photographic depiction of a long fiber thermoplastic molded plate formed from pellets that include a non-aqueous sizing composition and a coating composition formed of an ethoxylated fatty alcohol (ethyoxylation of n=20 and a C₁₈ fatty alcohol) applied under the bushing during fiber formation at an amount of 6.0% by weight; and

FIG. 19 is a photographic depiction of a long fiber thermoplastic molded plate formed from pellets that include a non-aqueous sizing composition and a coating composition formed of an ethoxylated fatty alcohol (ethyoxylation of n=100 and a C₁₈ fatty alcohol) applied under the bushing during fiber formation at an amount of 7.0% by weight.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

The terms “reinforcing fiber material” and “reinforcing fiber” may be used interchangeably herein. In addition, the terms “size”, “sizing”, “size composition” and “size formulation” may be used interchangeably herein. Additionally, the terms “film former” and film forming agent” may be used interchangeably. Also, the terms “composition” and “formulation” may be used interchangeably herein. Further, the terms “reinforcing fiber” and “reinforcement fiber” may be used interchangeably.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element or intervening elements may be present.

The present invention relates to a coating composition that improves fiber dispersion in a polymer matrix and improved composite performance properties such as mechanical properties to polymer reinforced composite articles under low shear molding conditions. Parameters such as screw speeds, pressures, and temperatures are adjusted to achieve a desired shear. Additionally, the type of resin material, melting points, viscosities, glass fiber concentration, and compounding additives may influence how a particular or desired shear is achieved. It is to be appreciated that the shear in long fiber thermoplastic molding processes are generally much lower compared to the shear in short fiber composite fabrication processes, at least in part, because of the design of the equipment used in long fiber thermoplastics, mold parameter settings, and the use of high melt flow index (MFI) polypropylene matrix resins (usually with lower melt viscosity). Due to improved glass fiber dispersion within the matrix resin, the inventive coating composition also imparts improved consistency in performance to the composite article. The coating composition includes a chemical compound or a mixture of chemical compounds that broadly acts as a wetting agent, a dispersing agent, an emulsifier, a surfactant, a compatibilizer, an adhesion promoter, and a melt viscosity reducer. It is preferred that the chemical compound is effective in wetting and dispersing the fibers quickly in a polymer matrix and in reducing the viscosity of polyolefins, such as a polypropylene matrix resin. Although not wishing to be bound by theory, it is believed that the chemical compound(s) of the coating composition promote wetting and dispersion of the reinforcing fibers in the polymer matrix.

The coating composition may be applied to a reinforcing fiber strand prior to impregnating, overcoating, or wire coating the strand with a thermoplastic resin. The reinforcing fiber strand may have been previously applied with an aqueous or non-aqueous sizing composition. In some exemplary embodiments, the coating composition may have been combined, at least partially, with the sizing composition. The reinforcing fiber strand may have been dried, especially if a conventional aqueous sizing is utilized, to remove water, either partially or completely, using a conventional oven and/or radio frequency (RF) drying equipment. Alternatively, the reinforcing fiber strand may be permitted to cool so as to achieve a solidified deposit of the applied molten, non-aqueous composition.

In one exemplary embodiment, the coating composition may be applied onto the reinforcement fibers when it is included as a component of a non-aqueous sizing composition and applied to the reinforcing fibers when the non-aqueous sizing is in a molten state. Desirably, the molten, non-aqueous sizing composition containing a desired amount of the coating composition is applied during the formation of the reinforcement fibers. The molten sizing composition solidifies onto the reinforcement fibers upon cooling. As a result, no further drying is necessary. The sized/coated fibers may be gathered into a reinforcing fiber strand that may be wound in-line during fiber manufacturing into an end-product package that is ready for pelletization processes, such as a high speed wire coating process.

In a further embodiment, the inventive coating composition may be partially incorporated into a conventional aqueous sizing composition (e.g., a composition containing lubricants, coupling agents, and film-forming binder resins) to be applied to reinforcement fibers, preferably during fiber formation. In particular, a desired quantity of the inventive coating composition may be included as part of the aqueous sizing composition applied to the reinforcement fibers. The resulting sized glass fibers may be dried using a conventional oven or radio frequency drying equipment. A second desired portion of the coating composition may be applied (e.g., in-line) to the sized reinforcement fibers which are gathered and formed into a reinforcing fiber strand. The reinforcing fiber strand may be dried prior to wire coating the fiber strand with a thermoplastic resin. In an alternate embodiment, the dried, sized fibers are wound into a package and stored for later use. The stored, sized fibers may be unwound and further processed at a later time by applying a second desired portion of the coating composition, drying or solidifying the coated strand, and wire coating the sized/coated strand with a thermoplastic polymer.

In another exemplary embodiment, the coating composition or components of the coating composition may be added, at least partially, to form a portion of the thermoplastic polymer compounding formulation that may be overcoated or wire coated onto the reinforcement strands. Preferably, the pelletization process is a wire coating process.

Typically, the coating composition is used to treat a continuous reinforcing fiber such as a strand, thread, or roving. For example, the reinforcing fiber material may be one or more strands of glass formed by conventional techniques such as by drawing molten glass through a heated bushing to form substantially continuous glass fibers. These fibers may subsequently be collected into a glass strand. Any type of glass, such as A-type glass, C-type glass, E-type glass, S-type glass, ECR-type glass fibers, boron-free fibers, (e.g., Advantex® glass fibers commercially available from Owens Corning), high strength glass or modifications thereof may be used. Preferably, the reinforcing fiber material is an E-type glass or Advantex® glass.

Alternatively, the reinforcing fiber material may be strands of one or more synthetic polymers such as, but not limited to, polyester, polyamide, aramid, polyaramid, polypropylene, polyethylene, and mixtures thereof. The polymer strands may be used alone as the reinforcing fiber material, or they can be used in combination with glass strands such as those described above. As a further alternative, carbon or other natural fibers may be used as the reinforcing fiber material. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof.

The reinforcing fiber material may include fibers that have a diameter of from about 6 microns to about 32 microns. In some embodiments, the fibers may have a diameter of more than 32 microns. Preferably, the fibers have a diameter from about 9 microns to about 28 microns. Most preferably, the fibers have a diameter from approximately 14 microns to approximately 24 microns. Each reinforcing fiber strand may contain from approximately 500 fibers to approximately 8,000 fibers or more.

After the reinforcing fibers are formed, and prior to their collection into a strand, a sizing composition may be applied by conventional methods such as by application rollers or by spraying the size composition directly onto the fibers. The size composition protects reinforcement fibers from breakage during subsequent processing, helps to retard interfilament abrasion, and ensures the integrity of the strands of reinforcing fibers, e.g., the interconnection of the reinforcing filaments that form the strand. The size composition applied to the reinforcing fibers may include one or more film forming agents (such as a polyurethane film former, a polyester film former, a polyolefin film former, a modified functionalized polyolefin, an epoxy resin film former, or other thermoplastic or waxy substances), at least one lubricant, and at least one silane coupling agent (such as an aminosilane or methacryloxy silane coupling agent). When needed, a weak acid such as acetic acid, boric acid, metaboric acid, succinic acid, citric acid, formic acid, phosphoric acid, and/or polyacrylic acids may be added to the size composition, such as, for example, to assist in the hydrolysis of the silane coupling agent.

In embodiments where the inventive coating composition is included as a portion of an aqueous sizing, the size composition may be applied to the reinforcing fibers during formation with a Loss on Ignition (LOI) from about 0.05% to about 2.0% or more on the dried fiber. As used in conjunction with this application LOI may be defined as the percentage of organic solid matter deposited on the reinforcement fiber surfaces. In embodiments where the inventive coating composition is partially or substantially a part of the non-aqueous sizing composition, the non-aqueous sizing may be applied to the glass fibers during formation with a LOI of from about 0.05% to about 15%. In some embodiments, the non-aqueous sizing may be applied with a LOI of greater than 15%. A preferred LOI is one the one that gives the desired handling, processing, composite properties, and fiber dispersion at the lowest cost. This amount may be determined by one of skill in the art on an individual case basis.

Film formers are agents which improve the handling, the processing of the glass fiber, and create improved adhesion between the glass fibers, which results in improved strand integrity. Suitable film formers for use in the present invention include polyurethane film formers, epoxy resin film formers, polyolefins, modified polyolefins, functionalized polyolefins, and saturated or unsaturated polyester resin film formers. Specific examples of aqueous dispersions, emulsions, and solutions of film formers include, but are not limited to, polyurethane dispersions such as Neoxil 6158 (available from DSM); polyester dispersions such as Neoxil 2106 (available from DSM), Neoxil 9540 (available from DSM), and Neoxil PS 4759 (available from DSM); and epoxy resin dispersions such as PE-412 (available from AOC), NX 9620 (available from DSM), Neoxil 0151 (available from DSM), Neoxil 2762 (DSM), NX 1143 (available from DSM), AD 502 (available from AOC), Epi Rez 5520 (available from Hexion), Epi Rez 3952 (available from Hexion), Witcobond W-290H (available from Chemtura), and Witcobond W-296 (available from Chemtura), polyolefin and modified polyolefin aqueous dispersions such as ME91735, ME 11340, MP4990 (available from Michelman, Inc), and a modified polyolefin aqueous dispersion based on high molecular weight maleated polypropylenes described in U.S. Pat. No. 6,818,698 to Sanjay Kashikar entitled “Aqueous Emulsification of High Molecular Weight Functionalized Polyolefins”, the content of which is incorporated herein by reference in its entirety. The molecular weight of such high molecular weight functionalized polyolefins may range from 10,000 to 120,000 or more. The film former(s), in the case of aqueous sizing compositions, may be present in the size composition from 0 to about 95% by weight of the active solids of the size, preferably from about 20 to about 80% by weight of the active solids.

Specific examples of non-aqueous film formers include, but are not limited to, thermoplastics, oxidized thermoplastics, functional thermoplastics, modified thermoplastics, and waxy substances such as Vybar260, Vybar825 (available from Baker Petrolite), and Polyboost130 (available from S&S Chemicals). In non-aqueous sizing compositions, the film former(s) may be present in the size composition from about 0 to about 99% by weight of the active solids, preferably from about 20 to about 98% by weight of the active solids.

The size composition also includes one or more silane coupling agents, in a partially or a fully hydrolyzed state or in a non-hydrolyzed state. The silane coupling agents may also be in monomeric, oligomeric or polymeric form prior to, during, or after their use. Besides their role of coupling the film forming agent(s) and/or the matrix resin to the surface of the reinforcing fibers, silanes also function to enhance the adhesion of the film forming copolymer component to the reinforcement fibers and to reduce the level of fuzz, or broken fiber filaments, during subsequent processing. Non-limiting examples of silane coupling agents which may be used in the present size composition may be characterized by the functional groups amino, epoxy, vinyl, methacryloxy, ureido, isocyanato, and azamido. In preferred embodiments, the silane coupling agents include silanes containing one or more nitrogen atoms that have one or more functional groups such as amine (primary, secondary, tertiary, and quarternary), amino, imino, amido, imido, ureido, isocyanato, or azamido. The silane coupling agent(s) may be present in the size composition in an amount from about 0.5 to about 30% by weight of the active solids in the size composition, preferably in an amount from about 2.0 to about 20% by weight of the active solids.

Suitable silane coupling agents include, but are not limited to, aminosilanes, silane esters, vinyl silanes, methacryloxy silanes, epoxy silanes, sulfur silanes, ureido silanes, and isocyanato silanes. Specific non-limiting examples of silane coupling agents for use in the instant invention include γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxy silane (A-188), methyltrimethoxysilane (A-1630), γ-ureidopropyltrimethoxysilane (A-1524). Other examples of suitable silane coupling agents are set forth in Table 1. All of the silane coupling agents identified above and in Table 1 are available commercially from GE Silicones.

TABLE 1

| Silanes | Label |
|---|---|
| Silane Esters | |
| Octyltriethoxysilane | A-137 |
| Methyltriethoxysilane | A-162 |
| Methyltrimethoxysilane | A-163 |
| Vinyl Silanes | |
| Vinyltriethoxysilane | A-151 |
| Vinyltrimethoxysilane | A-171 |
| vinyl-tris-(2-methoxyethoxy) | A-172 |
| silane | |
| Methacryloxy Silanes | |
| Γ-methacryloxypropyl- | A-174 |
| trimethoxysilane | |
| Epoxy Silanes | |
| β-(3,4-epoxycyclohexyl)- | A-186 |
| ethyltrimethoxysilane | |
| Sulfur Silanes | |
| γ- | A-189 |
| mercaptopropyltrimethoxysilane | |
| Amino Silanes | |
| γ-aminopropyltriethoxysilane | A-1101 |
| | A-1102 |
| aminoalkyl silicone | A-1106 |
| γ-aminopropyltrimethoxysilane | A-1110 |
| triaminofunctional silane | A-1130 |
| bis-(γ- | A-1170 |
| trimethoxysilylpropyl)amine | |
| Polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

In addition, the size composition may include at least one lubricant to facilitate fiber manufacturing and composite processing and fabrication. The lubricant may be present in the size composition in an amount from about 0 to about 20% by weight of the active solids in the size composition. Preferably, the lubricant is present in an amount from about 2.0 to about 15% by weight of the active solids. Although any suitable lubricant may be used, examples of lubricants for use in the sizing composition include, but are not limited to, water-soluble ethyleneglycol stearates (e.g., polyethyleneglycol monostearate, butoxyethyl stearate, polyethylene glycol monooleate, and butoxyethylstearate), ethyleneglycol oleates, ethoxylated fatty amines, glycerin, emulsified mineral oils, organopolysiloxane emulsions, carboxylated waxes, linear or (hyper)branched waxes or polyolefins with functional or non-functional chemical groups, functionalized or modified waxes and polyolefins, nanoclays, nanoparticles, and nanomolecules. Specific examples of lubricants suitable for use in the size composition include stearic ethanolamide, sold under the trade designation Lubesize K-12 (available from AOC); PEG 400 MO, a monooleate ester having about 400 ethylene oxide groups (available from Cognis); Emery 6760 L, a polyethyleneimine polyamide salt (available from Cognis); Lutensol ON60 (available from BASF); Radiacid (a stearic acid available from Fina); and Astor HP 3040 and Astor HP 8114 (microcrystalline waxes available from IGI International Waxes, Inc).

In at least one exemplary embodiment, the fibers may be sized with a sizing composition, gathered into a reinforcing fiber strand, and coated with the coating composition in-line prior to wire coating. Alternatively, the coating composition may be included as a component of the sizing composition and applied to the reinforcement fibers during fiber formation. The coating composition is used to aid in dispersing the reinforcement fibers within the matrix resin during the formation of the composite article. The coating composition may be applied as a non-aqueous composition or it may be transformed into an appropriate aqueous form and applied. The coating composition may be utilized at desired application locations during the fiber formation process or throughout the wire coating process prior to pelletization. The coating composition preferably has a low viscosity at the temperatures of use and is substantially free of an unreactive solvent. As used herein, an unreactive solvent is a solvent that evaporates out of the coating composition in the presence of heat energy (e.g., water).

The chemical compound or compounds in the coating composition may be ionic, non-ionic, or amphoteric in nature. It is desirable that the chemical compound is an ethoxylated fatty acid and/or an ethoxylated fatty alcohol having varying numbers of carbons in the fatty chain and varying numbers of ethylene oxide monomer units. Typical examples of such chemicals include Brij 78, Brij 76, and Brij 700 (all available from Uniquema) and PEG1500MS and PEG400MS (available from Lonza). The chemical compound may also be ethoxylated polyethylene, ethoxylated polypropylene, polyethylene oxide (PEO), ethylene oxide-propylene oxide copolymers, C₁₈-polyethylene oxide, C₁₆-polyethylene oxide, C₆-C₄₀-polyethylene oxide, ethoxylated fatty chains with carbons varying from about C₄ to about C₄₀ and ethylene oxide monomers units varying from about 2 to about 500, branched polyethylenes (e.g., Vybar compounds (available from Baker Petrolite), Polyboost compounds (available from S&S Chemicals)), polyethylene branched waxes, functionalized or non-functionalized linear micro-waxes, or branched functionalized or non-functionalized micro-waxes, functionalized or non-functionalized linear, branched, (hyper)branched, or dendrimeric polyolefins, modified or functional polyolefins (e.g., maleated polyolefins), oxidized or partially oxidized polyolefins and waxes, carboxylated polyolefins or waxes, copolymers or graft copolymers of olefins and acrylic or methacrylic acid, copolymers of polyolefins, adhesion promoters, compatibilizers, and coupling agents. The coating composition may be applied to the reinforcing fibers with a Loss on Ignition (LOI) from about 0.2 to about 15%, preferably from about 4.0 to about 12%, and more preferably from about 5.0 to about 10%. The coating composition may be applied to the reinforcing fibers by any conventional method, including kiss roll, dip-draw, and slide or spray application to achieve the desired amount of the coating composition on the fibers.

In addition, the coating composition may optionally contain additives to impose desired properties or characteristics to the coating composition and/or to the final composite product. Non-exclusive examples of additives include pH adjusters, UV stabilizers, antioxidants, acid or base capturers, metal deactivators, processing aids, oils, lubricants, antifoaming agents, antistatic agents, thickening agents, adhesion promoters, compatibilizers, coupling agents, stabilizers, flame retardants, impact modifiers, pigments, dyes, colorants, odors, masking fluids, and/or fragrances. The additives may be present in the coating composition from trace amounts (such as less than about 0.02% by weight of the coating composition) up to about 95% by weight. Thus, in at least one exemplary embodiment, the additives are components of the coating composition and are applied to the reinforcement fibers simultaneously with the chemical compound. In an alternate embodiment, the desired additives are added separately from the chemical compound in multiple steps in-line or off-line until the desired final coating composition is achieved (i.e., the chemical compound and all of the desired additives). In a further alternate embodiment, the desired additives or the components of the coating compositions are added, at least partially, to the thermoplastic polymer compounding formulation (i.e., separately from the chemical compound(s)) that is used for overcoating the reinforcement fibers with a thermoplastic resin, typically by a wire coating process.

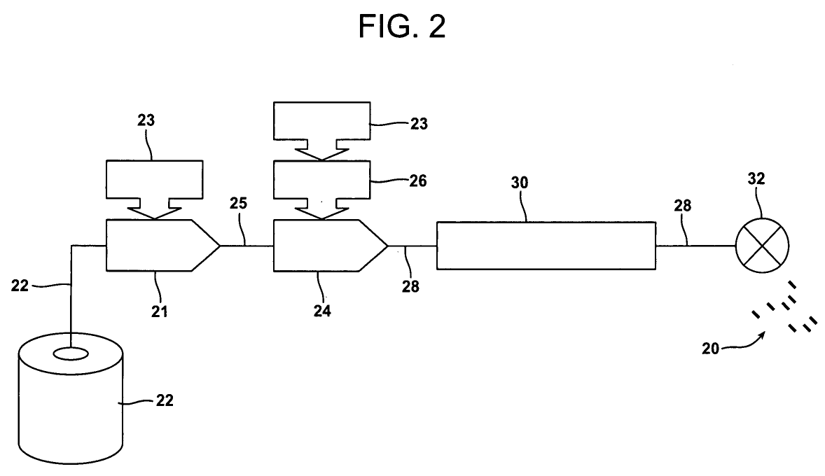

FIG. 2 illustrates one exemplary embodiment for chemically treating a plurality of reinforcement fibers suitable for making a composite article. After molding the compounded pellets produced by the pelletization process, the formed composite article includes a plurality of reinforcement fibers dispersed in a matrix of a polymeric material. It is preferred that the reinforcement fibers are continuously formed glass fibers coated with a conventional sizing composition such as is described in detail above. The reinforcement fibers may alternatively be preformed fibers coated with a conventional size composition. The term “preformed” is meant to indicate that the reinforcement fibers have been previously coated off-line with a sizing composition.

In the embodiment illustrated in FIG. 2, a reinforcement fiber strand 22 formed of individual reinforcement fibers sized with a conventional sizing composition are substantially evenly coated with the coating composition 21 and any desired additives 23 to form a coated reinforcement fiber strand 25. As used herein, “substantially evenly coated” is meant to indicate that the reinforcement fiber strand 22 is completely coated or nearly completely coated with the coating composition 21 of the present invention. An applicator (not shown) is used to apply the coating composition 21 to the reinforcement fiber strand 22. The applicator may be any conventional or any other construction suitable for applying the desired amount of the coating composition 21 to the reinforced fiber strand 22 at the desired speeds of pelletization production. The applicator ensures proper delivery of the coating composition 21 in desired or proper amounts to the reinforcement fibers 22. Accurate delivery of the coating composition 21 results in an even or substantially even coating over the surface of the reinforcing fiber pulled over or through the applicator. The coating composition 21, with or without additives 23, may be applied to the sized reinforcement fibers 22 to achieve an amount from about 0.2 to about 15% by weight on the fibers, preferably from about 4 to about 12% by weight on the fibers, and more preferably from about 5 to about 10% by weight on the fibers.

The coated reinforced fiber strand 25 is then pulled or otherwise passed through a wire coating apparatus 24. The wire coater 24 substantially evenly coats a thermoplastic polymer 26 circumferentially around the sized reinforcement fiber strands 25 to form a size/coated fiber strand 28. A wire coater 24 may be a device or group of devices capable of coating one or more strands of fibers with a polymeric material 26 so as to form a sheath of relatively uniform thickness on the fiber strands. It is desirable that the wire coater 24 includes a die or other suitable device that shapes the sheath to a desired and uniform thickness or cross-section. Additional coating components such as wetting agents, dispersing agents, emulsifiers, surfactants, compatibilizers, adhesion promoters, melt viscosity reducers, pH adjusters, UV stabilizers, antioxidants, acid or base capturers, metal deactivators, processing aids, oils, lubricants, antifoaming agents, antistatic agents, thickening agents, adhesion promoters, coupling agents, stabilizers, flame retardants, impact modifiers, pigments, dyes, colorants, odors, masking fluids, and/or fragrances (not shown in FIG. 2) may be at least partially added together with the polymeric material 26.

Examples of suitable thermoplastic polymers 26 include polypropylene, polyester, polyamide, polyethylene, polyethylene terephthalate (PET), polyphenylene sulfide (PPS), polyphenylene ether (PPE), polyetheretherketone (PEEK), polyetherimides (PEI), polyvinyl chloride (PVC), ethylene vinyl acetate/vinyl chloride (EVA/VC), lower alkyl acrylate polymers, acrylonitrile polymers, partially hydrolyzed polyvinyl acetate, polyvinyl alcohol, polyvinyl pyrrolidone, styrene acrylate, polyolefins, polyamides, polysulfides, polycarbonates, rayon, nylon, phenolic resins, and epoxy resins. The polymer 26 may be applied to the sized/coated reinforcement fibers 25 to achieve an amount from about 5.0 to about 95% by weight based on the total weight of the glass reinforced compounded pellets, preferably from about 15.0 to about 90% by weight, and most preferably from about 20.0 to about 85% by weight.

After the thermoplastic polymer 26 and any desired or applicable additives 23 are applied to the sized/coated reinforcement fibers 25, the fibers 28 may be cooled by a cooling apparatus 30 (e.g., a water bath) to solidify the thermoplastic polymer 26 onto the reinforcement fibers 28. The sized/coated reinforcement fibers 28 may also (or alternatively) be air cooled and/or air-dried. In at least one exemplary embodiment, the sized/coated reinforcement fibers 25 are pre-dried or the thermoplastic polymer 26 is solidified in a convection oven or in a radio frequency (RF) apparatus (not shown) prior to entering the wire coating apparatus 24. The fibers 25 and/or fibers 28 may be conditioned (heated or cooled) by any methods to achieve improved chopping, pellet quality, and/or improved composite properties. The coated/sized reinforcement fibers 28 may be chopped into segments and formed into pellets 20 utilizing a pelletizing apparatus 32. The chopped strand segments may have a length from approximately 3 mm to approximately 50 mm. Preferably, the segments have a length from about 6 mm to about 25 mm. Any suitable method or apparatus known to those of ordinary skill for chopping glass fiber strands or wire-coated fiber strands into segments may be used.

The pellets 20 may be classified by size using a screen or other suitable device. The pellets 20 may be fed to a molding machine and formed into molded composite articles that have a substantially homogeneous dispersion of glass fiber strands throughout the composite article, even under low shear molding conditions. As used herein, the phrases “substantially homogeneous distribution of fibers” is meant to denote that the fibers are uniformly or evenly distributed or nearly uniformly or evenly distributed throughout the final composite article. The process of manufacturing the composite product may be conducted either in-line, i.e., in a continuous manner, or in individual steps.

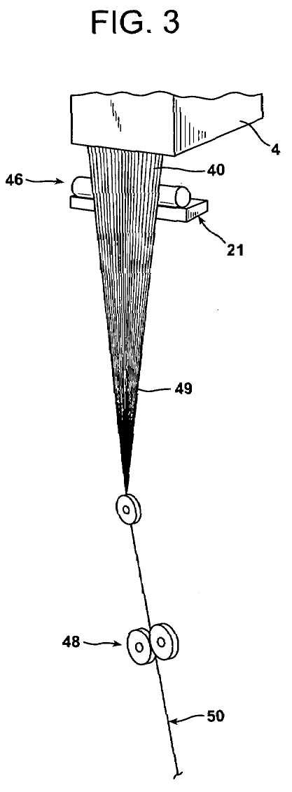

In an alternative embodiment, the coating composition is applied to reinforcement fibers under a bushing after the formation of the reinforcement fibers. An example of such an application of the coating composition is illustrated in FIG. 3. In this embodiment, reinforcement fibers 40 (e.g., glass fibers) are drawn from a bushing 42 with the assistance of a pulling mechanism (not shown). In this embodiment, the inventive coating composition is included as a component of a non-aqueous sizing composition that is applied to the reinforcement fibers as they are formed. Typically, a non-aqueous sizing composition may include components such as a silane coupling agent, a film forming agent, a lubricant, and other specific additives needed during fiber manufacturing and post-processing the reinforcement fibers into composite articles. The non-aqueous sizing composition may be characterized by the substantial non-aqueous nature or state of the ingredients during their use and application onto the reinforcing fibers or reinforcing fiber strands. It is to be noted that the coating composition may be included as a component of an aqueous sizing composition and applied in a similar manner.

As shown in FIG. 3, a non-aqueous sizing composition containing the inventive coating composition 21 may be applied to reinforcement fibers 40 after they are drawn from a bushing 42 by any conventional applicator 46, such as the roll applicator depicted in FIG. 3. The molten, non-aqueous sizing composition solidifies onto the reinforcement fibers 40 upon cooling. Thus, no further drying of the reinforcement fibers is necessary. The coated reinforcement fibers 49 may be gathered by a gathering mechanism 48 to form coated reinforcement fiber strands 50. The coated strands 50 may then be wound into a continuous fiber strand package or chopped into a desired length (not shown). Any suitable method or apparatus known to those of ordinary skill for chopping glass fiber strands into segments may be used. Subsequently, the coated fibers (continuous or chopped) may be pelletized into pellets utilizing a pelletizing apparatus and molded under low shear conditions into reinforced composite articles (not shown in FIG. 3).

The coated strands may be fed directly into direct long fiber thermoplastic (D-LFT) machines to produce a long fiber thermoplastic composite article with a good dispersion of fibers throughout the composite part. Long fiber thermoplastic processing, especially wire coating pelletization, is advantageous from both a processing and economical point of view. These advantageous properties are primarily due to longer fiber retention inside the pellets, reduced strand damage during processing and manufacturing, and higher line speeds as compared to short fiber pelletization processes. The process of manufacturing the composite product may be conducted either in-line or in individual steps. It is desirable that the sizing/coating composition 21 is applied to the reinforcement fibers 40 with a Loss on Ignition of at least about 2.0%, preferably at least about 4.0%, and most preferably at least about 6.0%.

Composite articles formed from fibers coated with the coating composition of the present invention demonstrate improved mechanical properties (e.g., tensile strength and impact strength) and excellent fiber dispersion, even when molded under low shear conditions. Another advantage of the coating formulation of the present invention is that the coating composition assists in substantially evenly dispersing the reinforcement fibers in the final composite article. Such improved dispersion of the reinforcement fibers causes fewer visual defects in the composite article. A further advantage of the coating composition is that due to improved dispersion of the fibers, the composite part quality and consistency in performance is enhanced.

Having generally described this invention, a further understanding can be obtained by reference to certain specific examples illustrated below which are provided for purposes of illustration only and are not intended to be all inclusive or limiting unless otherwise specified.

### EXAMPLES

In the Examples set forth below, homopolypropylene (MFI=40) was utilized in the wire coating processes. The homopolypropylene was pre-blended with a standard maleated coupling agent (Exxelor 1020) and a stabilizer package to form a compounding formulation. This compounding formulation was used in each of the Examples described below. Additionally, in the Examples, the glass content was maintained at 30% by weight of the final glass fiber reinforced compounded pellet. The molding of the pellets was performed on a Battenfeld molding machine operating at long fiber thermoplastic (LFT) low shear molding conditions. The quality of the dispersion of the fibers in the molded composite plates was assessed based on visual inspection by manually counting the undispersed fiber bundles, which appeared as white spots on the plate surfaces, photographs and, X-rays.

### Example 1

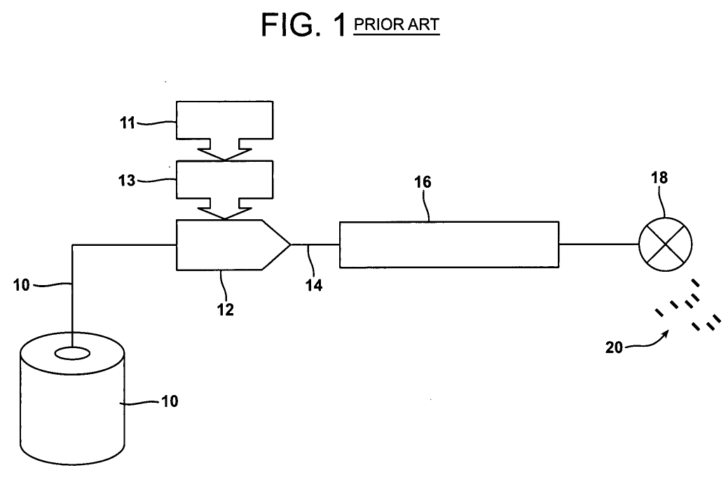

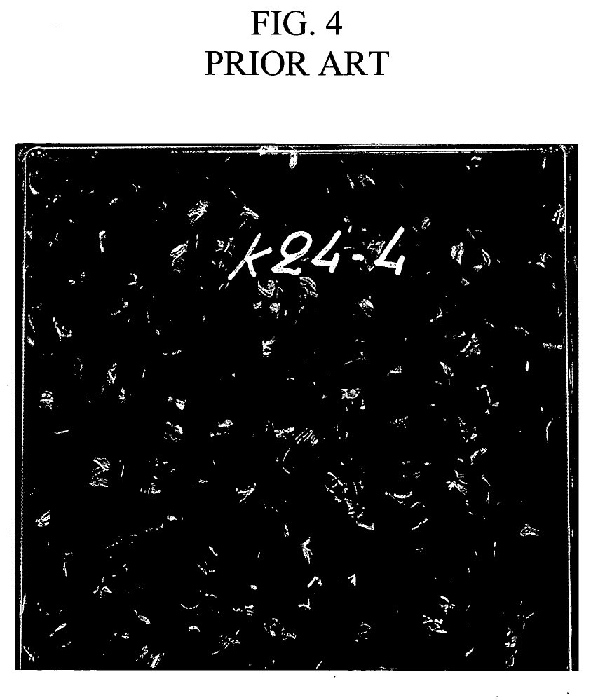

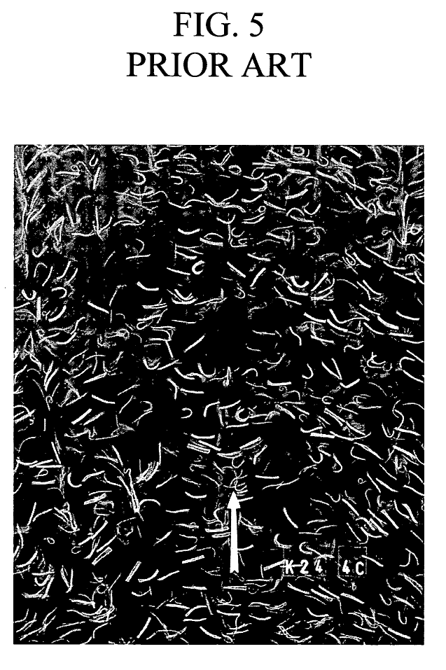

A continuous glass fiber that had been pre-applied with an aqueous, conventional sizing composition (i.e., including a film forming agent, a coupling agent, and a lubricant) and dried in a conventional oven was utilized as the input fiber material in a wire coating process. The input fiber material was wire coated using the wire coating process depicted in FIG. 1. The wire-coated strand was then passed through a cooling bath and chopped into pellets having length of approximately 12 mm and a glass content of 30% by weight. The pellets were then molded into a molded plate using a molding machine used for producing long fiber thermoplastic (LFT) molded plates. As shown in FIG. 4, the molded plate contained numerous undispersed fiber bundles over the entire surface of the plate (shown as white spots on the plate). An X-ray of the molded plate was produced (FIG. 5). The X-ray clearly shows undispersed fiber bundles throughout the plate as white spots. It is to be appreciated that no inventive coating composition was utilized in this example.

### Example 2

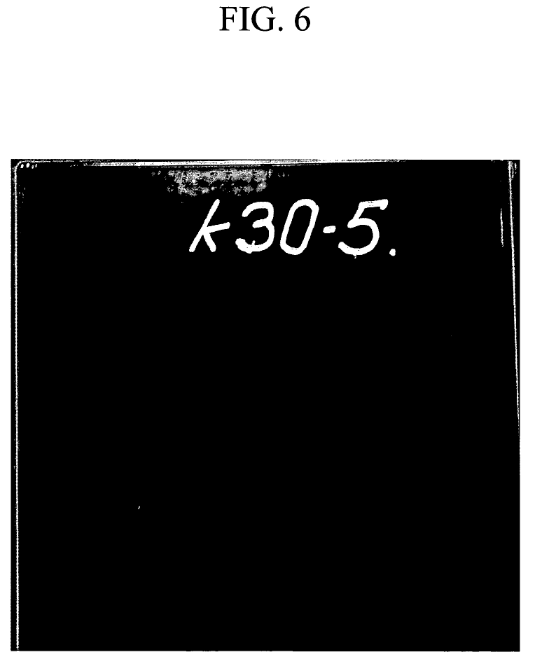

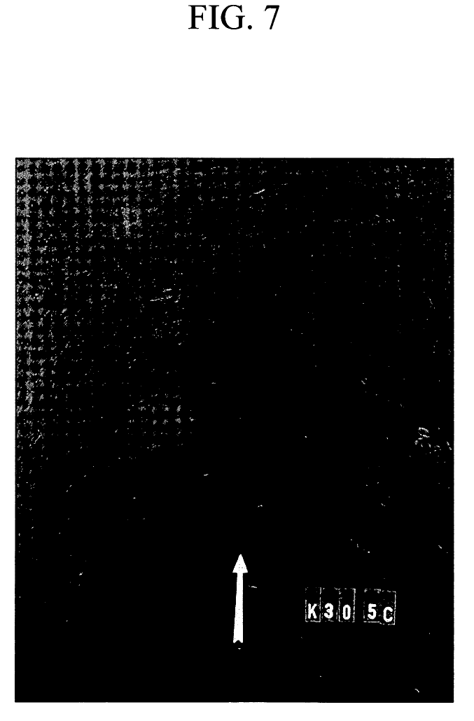

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty alcohol (ethoxylation with n=20 ethylene oxide monomers and a C₁₈ fatty alcohol) was applied in-line as shown in FIG. 2 at a level of 10% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 6. It can be seen in FIG. 6 that the molded plated formed by utilizing fiber strands coated with the inventive coating composition has less undispersed glass fibers bundles than the comparative example (i.e., no coating composition) set forth in FIGS. 4 and 5. This reduction in undispersed fiber bundles is further shown in the X-ray produced from the molded plate of FIG. 6. (See, FIG. 7). Thus, it can be concluded that the use of the coating composition according to the present invention greatly reduces the number of undispersed fiber bundles in the final composite part.

Test samples from the molded plate of FIG. 4 (no coating composition) and the molded plate of FIG. 6 (coating composition applied to the glass fiber strand) were obtained and tested for tensile strength. The tensile strength measured on the sample from the molded plate of FIG. 4 was determined to be 110 MPa and the tensile strength from the test sample from the molded plate of FIG. 6 was determined to be 123 MPa. Therefore, the RF dried glass fiber strands containing the inventive coating composition demonstrated an improvement in tensile strength in the molded part.

### Example 3

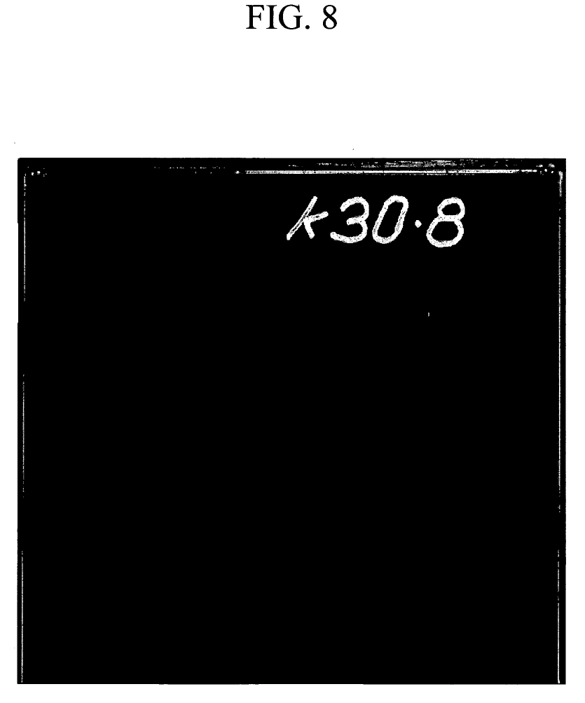

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty alcohol (ethoxylation with n=20 ethylene oxide monomers and a C₁₈ fatty alcohol) was applied in-line as shown in FIG. 2 at a level of 8.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is set forth in FIG. 8. It can be seen in FIG. 8 that the molded plated formed by utilizing fiber strands coated with the inventive coating composition has considerably less undispersed glass fibers bundles than the comparative example (i.e., no coating composition) set forth in FIGS. 4 and 5. Thus, a significant improvement in the dispersion of the glass fibers is demonstrated by the glass fiber strands coated with the inventive coating composition.

### Example 4

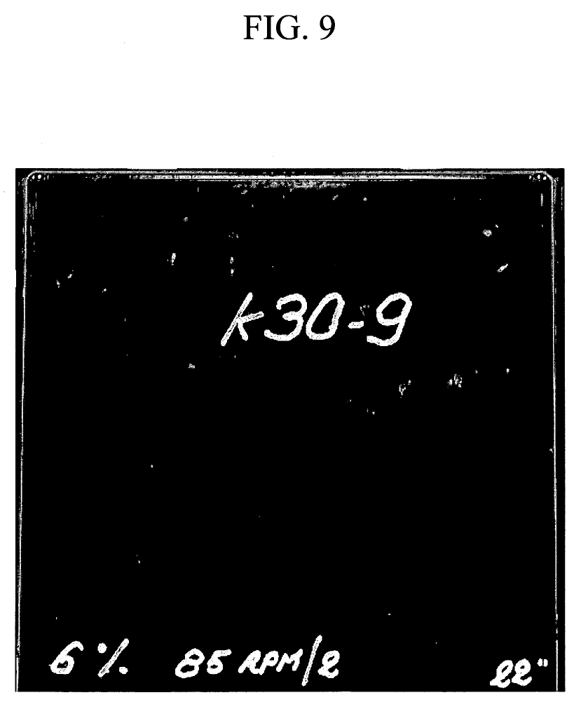

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty alcohol (ethoxylation with n=20 ethylene oxide monomers and a C₁₈ fatty alcohol) was applied in-line as shown in FIG. 2 at a level of 6.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is set forth in FIG. 9. It can be seen in FIG. 9 that the molded plated formed by utilizing fiber strands coated with the inventive coating composition has considerably less undispersed glass fibers bundles than the comparative example (i.e., no coating composition) set forth in FIGS. 4 and 5. Thus, a significant improvement in the dispersion of the glass fibers is demonstrated by the glass fiber strands coated with the inventive coating composition.

### Example 5

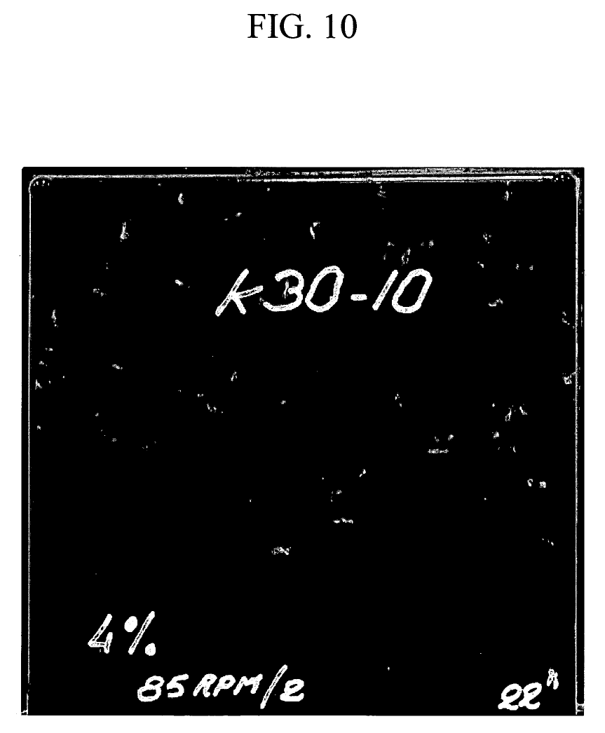

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty alcohol (ethoxylation with n=20 ethylene oxide monomers and a C₁₈ fatty alcohol) was applied in-line as shown in FIG. 2 at a level of 4.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is set forth in FIG. 10. It can be seen in FIG. 10 that the molded plated formed by utilizing fiber strands coated with the inventive coating composition has considerably less undispersed glass fibers bundles than the comparative example (i.e., no coating composition) set forth in FIGS. 4 and 5. Thus, significant improvement in the dispersion of the glass fibers is demonstrated by the glass fiber strands coated with the inventive coating composition, even at a lower concentration.

### Example 6

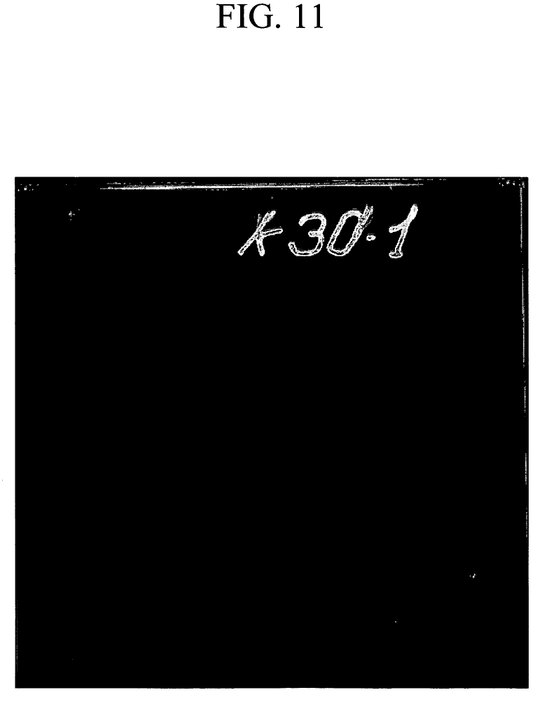

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty acid (PEG1500MS) was applied in-line as shown in FIG. 2 at a level of 10% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 11. It can be seen in FIG. 11 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention greatly reduces the number of undispersed fiber bundles in the final composite part.

### Example 7

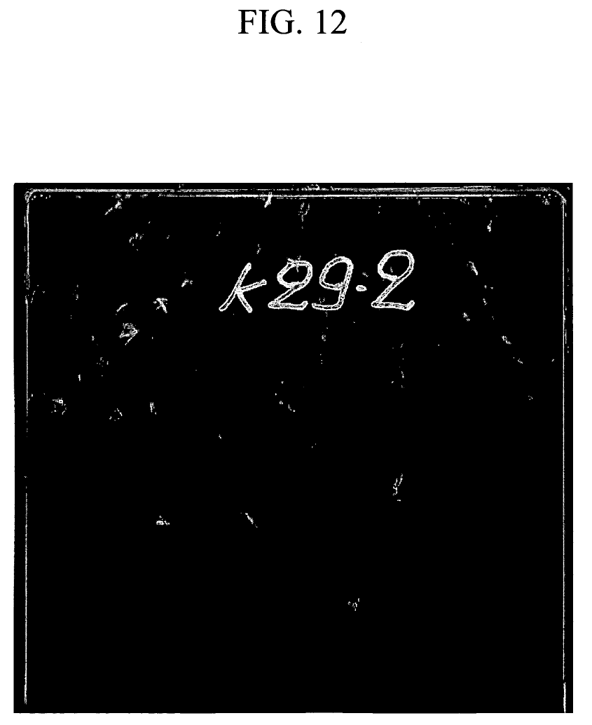

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty acid (PEG1500MS) was applied in-line as shown in FIG. 2 at a level of 7.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 12. It can be seen in FIG. 12 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention greatly reduces the number of undispersed fiber bundles in the final composite part, even at a lower concentration.

### Example 8

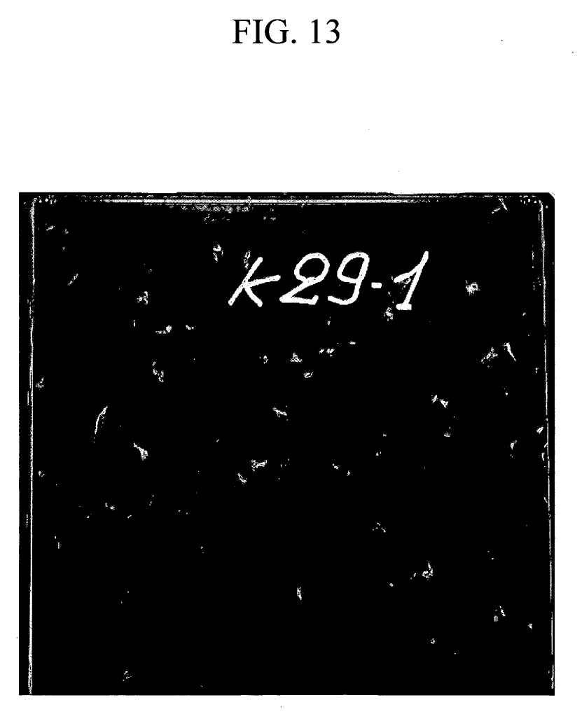

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty acid (PEG15000MS) was applied in-line as shown in FIG. 2 at a level of 5.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 13. It can be seen in FIG. 13 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention reduces the number of undispersed fiber bundles in the final composite part, even at lower concentrations

### Example 9

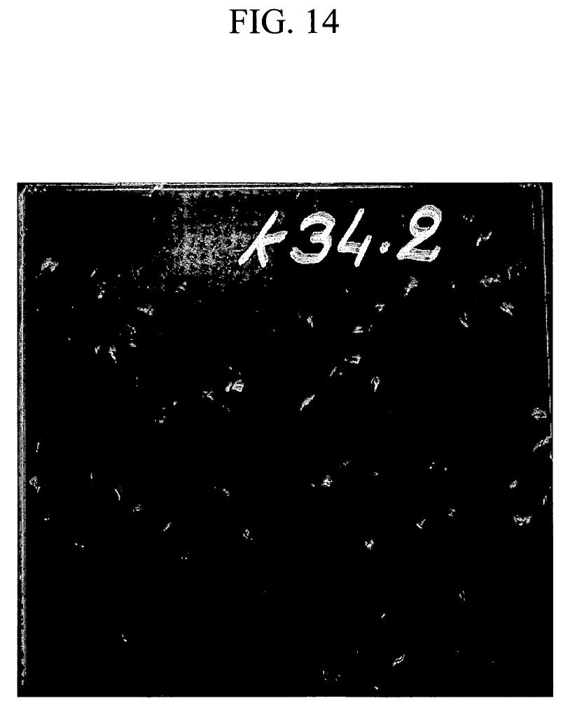

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of a low molecular weight maleated polypropylene (Licoene 1332) was applied in-line as shown in FIG. 2 at a level of 8.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 14. It can be seen in FIG. 14 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention reduces the number of undispersed fiber bundles in the final composite part.

### Example 10

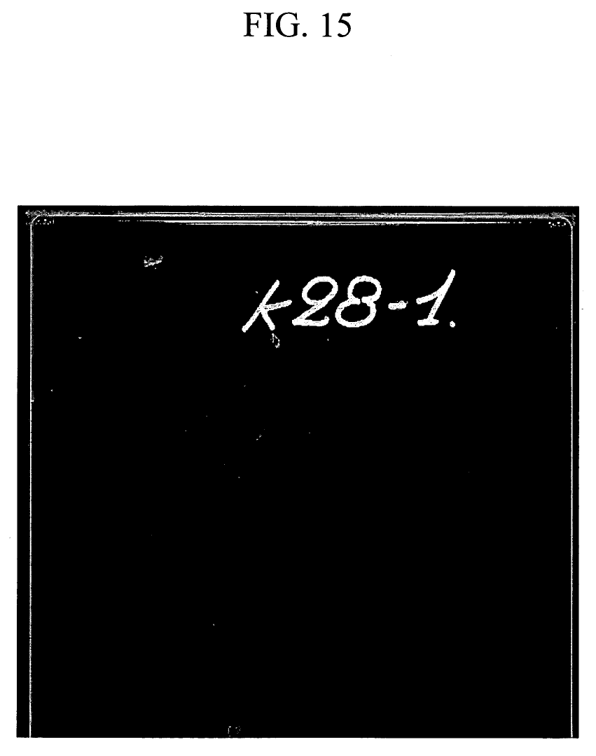

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of a mixture of hyperbranched polyethylene (Vybar 260) blended with two different microcstalline waxes was applied in-line as shown in FIG. 2 at a level of 10.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 15. It can be seen in FIG. 15 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention reduces the number of undispersed fiber bundles in the final composite part.

### Example 11

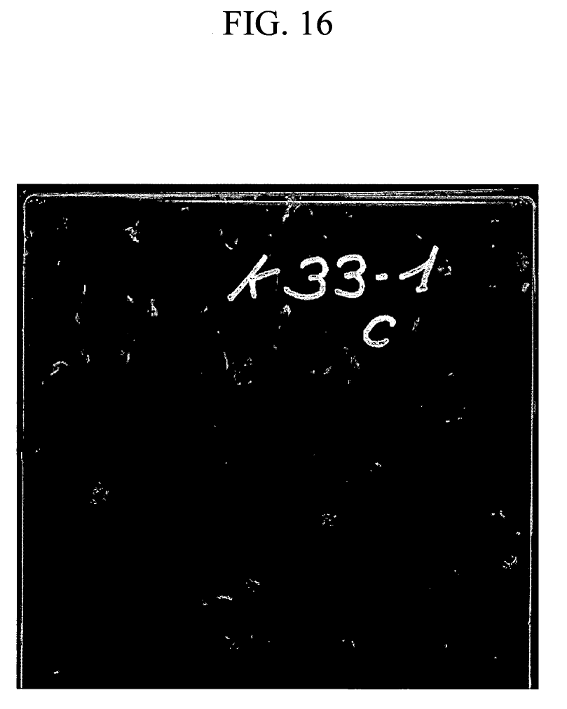

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty alcohol (ethoxylation with n=9-11 ethylene oxide monomers and a C₆ fatty alcohol) was applied in-line as shown in FIG. 2 at a level of 8.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 16. It can be seen in FIG. 16 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention reduces the number of undispersed fiber bundles in the final composite part.

### Example 12

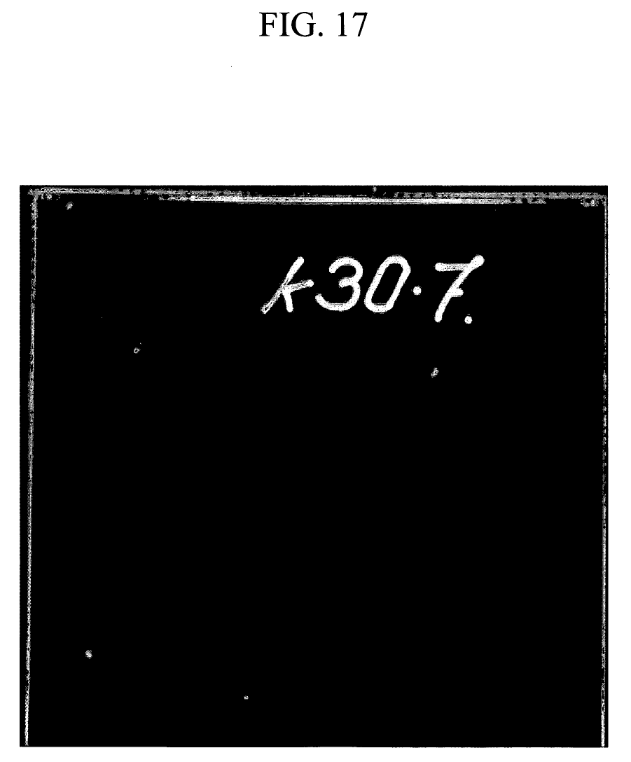

A continuous glass fiber pre-applied with an aqueous, conventional sizing composition (i.e., including a film forming agent, a coupling agent, and a lubricant) and dried in a radio frequency drying apparatus was utilized as the input fiber material in a wire coating process. A coating composition formed of an ethoxylated fatty alcohol (ethoxylation with n=10 ethylene oxide monomers and a C₁₈ fatty alcohol) was applied in-line as shown in FIG. 2 at a level of 8.0% by weight prior to running the coated glass fiber strand through the wire coating device. The wire-coated strand was then passed through a cooling bath and chopped into pellets having length of approximately 12 mm. The pellets were then molded into a molded plate using a molding machine used for producing long fiber thermoplastic (LFT) molded plates. A photograph of the molded plate is shown in FIG. 17. It can be seen in FIG. 17 that the molded plated formed by utilizing fiber strands coated with the inventive coating composition has less undispersed glass fibers bundles than the comparative example (i.e., no coating composition) set forth in FIGS. 4 and 5. Thus, it can be concluded that the use of a coating composition according to the present invention reduces the number of undispersed fiber bundles in the final composite part.

### Example 13

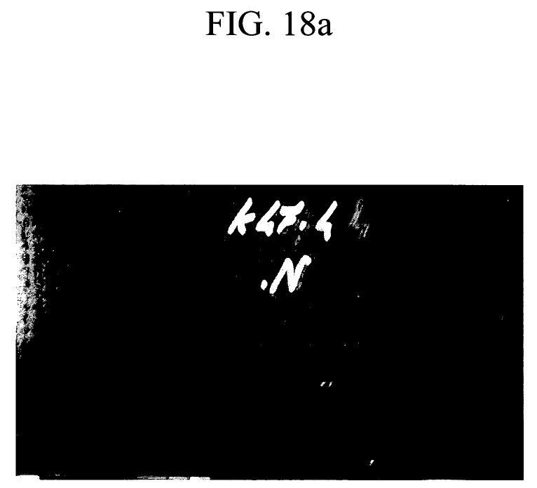

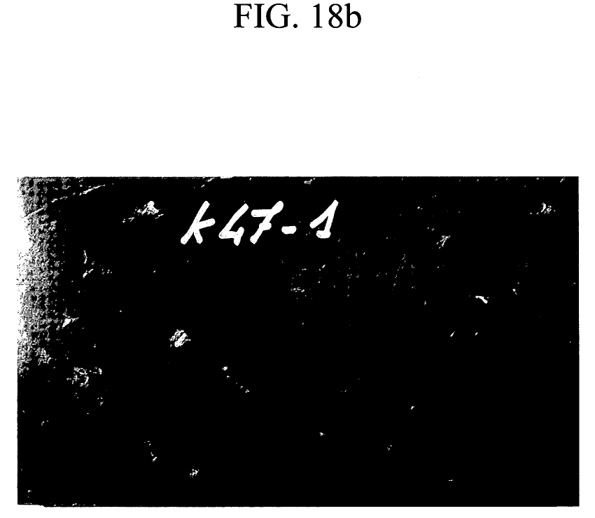

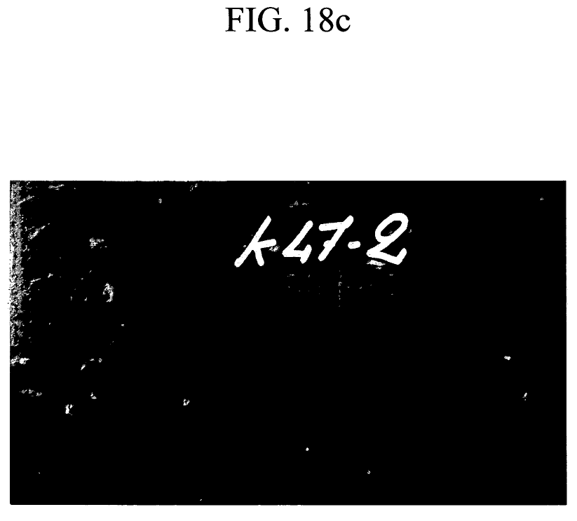

A continuous glass fiber was impregnated with a non-aqueous sizing composition and a coating composition formed of an ethoxylated fatty alcohol (ethoxylation with n=20 and a C₁₈ fatty alcohol) during the manufacturing (e.g., forming) of the glass fibers as shown in FIG. 3. The total composition (i.e., the non-aqueous sizing composition plus the coating composition) was applied to the glass fibers at a level of 8.0% (FIG. 18a), 7.0% (FIG. 18b), and 6.0% (FIG. 18c) based on the weight of the fibers, where the coating composition was made a substantial part of the non-aqueous sizing composition. The molten composition (sizing composition and coating composition) was applied to the glass fibers and permitted to cool and solidify on the fibers. The glass fibers were wound into continuous fiber wound packages, which were then used for wire coating. The sized/coated fiber strands were then passed through a cooling bath and chopped into pellets having length of approximately 12 mm. The pellets were then molded into a molded plate using a molding machine used for producing long fiber thermoplastic (LFT) molded plates. As depicted in FIGS. 18a-18c, there is a significant improvement of the dispersion of fiber bundles than the comparative example (i.e., no coating composition) set forth in FIGS. 4 and 5. Thus, it can be concluded that the use of a coating composition according to the present invention reduces the number of undispersed fiber bundles in the final composite part.

### Example 14

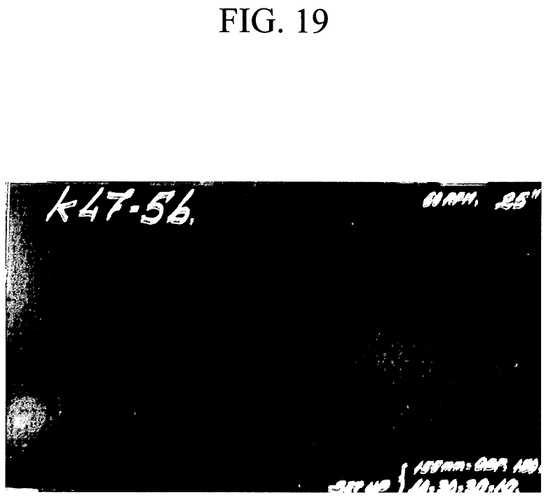

A continuous glass fiber was impregnated with a non-aqueous sizing composition and a coating composition formed of an ethoxylated fatty alcohol (ethoxylation with n=100 and a C₁₈ fatty alcohol) during the manufacturing (e.g., forming) of the glass fibers as shown in FIG. 3. The total composition (i.e., non-aqueous sizing composition plus coating composition) was applied to the glass fibers at a level of 7.0% based on weight of the fibers, where the coating composition was made a substantial part of the non-aqueous sizing composition. The molten composition applied to the glass fibers was allowed to cool and solidify on the fibers. The glass fibers were wound into continuous fiber wound packages, which were then used for wire coating. The sized/coated fiber strands were then passed through a cooling bath and chopped into pellets having length of approximately 12 mm. The pellets were then molded into a molded plate using a molding machine used for producing long fiber thermoplastic (LFT) molded plates. As depicted in FIG. 19, there is a significant improvement of the dispersion of fiber bundles than the comparative example (i.e., no coating composition) set forth in FIGS. 4 and 5. Thus, it can be concluded that the use of a coating composition according to the present invention reduces the number of undispersed fiber bundles in the final composite part.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A reinforcing fiber strand comprising:
a reinforcing fiber strand formed of a plurality of individual reinforcing fibers at least partially coated with a sizing composition, wherein at least one of said individual reinforcing fibers and said reinforcing fiber strand is at least partially coated with a coating composition that includes one or more chemical compounds to improve dispersion of said plurality of reinforcing fibers in a polymer matrix.

2. The reinforcing fiber strand of claim 1, wherein said sizing composition is positioned on said individual reinforcing fibers and said coating composition forms an external coating on said reinforcing fiber strand, said sizing composition containing at least one member selected from the group consisting of a film forming agent, a coupling agent and a lubricant.

3. The reinforcing fiber strand of claim 1, wherein said sizing composition is a non-aqueous sizing composition and said coating composition is incorporated as a component of said non-aqueous sizing composition, said non-aqueous sizing composition containing said coating composition being positioned on said individual reinforcing fibers.

4. The reinforcing fiber strand of claim 1, wherein said sizing composition is an aqueous sizing composition that includes at least one member selected from the group consisting of a film forming agent, a coupling agent and a lubricant, said sizing composition being positioned on said individual reinforcing fibers, and wherein a first portion of said coating composition is incorporated as a component of said aqueous sizing composition.

5. The reinforcing fiber strand of claim 4, wherein a second portion of said coating composition is applied to said reinforcing fiber strand.

6. The reinforcing fiber strand of claim 1, wherein said reinforcing fiber strand is at least partially circumferentially encased by a thermoplastic polymer.

7. The reinforcing fiber strand of claim 1, wherein said one or more chemical compounds is selected from the group consisting of an ethoxylated fatty acid, an ethoxylated fatty alcohol, polyethylene oxide, ethylene oxide-propylene oxide copolymers, C₆-C₁₅-polyethylene oxide, C₁₆-polyethylene oxide, C₁₇-polyethylene oxide, C₁₈-polyethylene oxide, C₁₉-C₄₀-polyethylene oxide, ethoxylated fatty chains, ethoxylated polyethylene, ethoxylated polypropylene, branched polyethylenes, polyethylene branched waxes, functionalized linear micro-waxes, non-functionalized linear micro-waxes, branched functionalized micro-waxes, non-functionalized micro-waxes, functionalized linear polyolefins, functionalized branched polyolefins, fuctionalized hyperbranched polyolefins, functionalized dendrimeric polyolefins, non-functionalized linear polyolefins, non-functionalized branched polyolefins, non-fuctionalized hyperbranched polyolefins, non-functionalized dendrimeric polyolefins, maleated polyolefins, oxidized polyolefins, partially oxidized polyolefins, oxidized waxes, partially oxidized waxes, carboxylated polyolefins, carboxylated waxes, copolymers of polyolefins, copolymers of olefins and acrylic acid, copolymers of olefins and methacrylic acid, graft copolymers of olefins and acrylic acid, graft copolymers of olefins and methacrylic acid, adhesion promoters, compatibilizers and coupling agents.

8. A reinforcing fiber product comprising two or more reinforcing fiber strands formed of a plurality of reinforcing fibers, wherein one or both of said reinforcing fiber strands and said reinforcing fibers is at least partially coated with a coating composition that includes one or more chemical compounds to improve dispersion of said plurality of reinforcing fibers in a polymer matrix.

9. The reinforcing fiber product of claim 8, wherein said plurality if reinforcing fibers have thereon a layer of an aqueous sizing composition that includes at least one member selected from the group consisting of lubricants, coupling agents and film-forming binder resins and said coating composition forms an external coating on said two or more reinforcing fibers strands.

10. The reinforcing fiber product of claim 8, wherein said sizing composition is a non-aqueous sizing composition and said coating composition is incorporated as a component of said non-aqueous sizing composition, said non-aqueous sizing composition containing said coating composition being positioned on said reinforcing fibers.

11. The reinforcing fiber product of claim 8, wherein said sizing composition is an aqueous sizing composition that includes at least one member selected from the group consisting of a film forming agent, a coupling agent and a lubricant, said sizing composition being positioned on said reinforcing fibers, and wherein a portion of said coating composition is incorporated as a component of said aqueous sizing composition.

12. The reinforcing fiber product of claim 8, wherein said coating composition further comprises additives to impose desired properties or characteristics to said reinforcing fiber product.

13. The reinforcing fiber product of claim 8, wherein said chemical compound is selected from the group consisting of an ethoxylated fatty acid, an ethoxylated fatty alcohol and mixtures thereof.

14. The reinforcing fiber product of claim 8, wherein said two or more reinforcing fiber strands are at least partially encased by a thermoplastic resin.

15. The reinforcing fiber product of claim 8, wherein said reinforcing fiber product is in the form of a pellet.

16. A method of forming a reinforced composite article comprising:
at least partially coating a reinforcing fiber strand formed of a plurality of individual reinforcement fibers at least partially coated with a sizing composition, wherein one or both of said individual reinforcing fibers and said reinforcing fiber strand is at least partially coated with a coating composition that includes one or more chemical compounds to improve dispersion of said plurality of individual reinforcement fibers in a polymer matrix to form a coated fiber strand;
at least partially surrounding said coated fiber strand with a thermoplastic polymer;
pelletizing said polymer-coated fiber strand into a pellet; and
molding said pellet under molding conditions having a shear lower than conventional long fiber thermoplastic processing to form a reinforced composite article.

17. The method of claim 16, further comprising:
incorporating a portion of said coating composition into said sizing composition, said sizing composition being an aqueous sizing composition.

18. The method of claim 16, further comprising:
drying one or both of said reinforcement fibers and said reinforcing fiber strand by radio frequency drying equipment prior to pelletizing said coated fiber strand.

19. A method of forming a reinforced composite article comprising:
at least partially coating reinforcing fibers with a non-aqueous sizing composition that contains a coating composition having at least one chemical compound to improve dispersion of said reinforcing fibers in a polymer matrix;
gathering said coated reinforcing fibers to form a coated reinforcing fiber strand;
at least partially surrounding said coated reinforcing fiber strand with a thermoplastic polymer;
pelletizing said polymer-coated fiber strand into a pellet; and
molding said pellet under molding conditions that have a shear lower than conventional molding processing to form a reinforced composite article.

20. The method of claim 19, wherein said at least one chemical compound is selected from the group consisting of an ethoxylated fatty acid, an ethoxylated fatty alcohol and mixtures thereof.
